(19) United States
(12) Patent Application Publication
(10) Pub. No.: US 2008/0113538 A1
(43) Pub. Date: May 15, 2008

(54) Compressor

(75) Inventor: Masanori Masuda, Osaka (JP)

Correspondence Address: GLOBAL IP COUNSELORS, LLP, 1233 20TH STREET, NW, SUITE 700, WASHINGTON, DC, 20036-2680, US

(73) Assignee: Daikin Industries. Ltd., Osaka-shi (JP)

(21) Appl. No.: 11/792,320

(22) PCT Filed: Dec. 5, 2005
(86) PCT No.: PCT/JP05/22279

§ 371 Date: Jun. 5, 2007

(30) Foreign Application Priority Data
Dec. 6, 2004 (JP) 2004-352612

(51) Int. Cl. H01R 3/08

(52) U.S. Cl. 439/179

(57) ABSTRACT

A fixing bolt is inserted into a through hole of an end-face member and screwed with a screw hole of a valve holding member, by which a discharge valve is sandwiched by the end-face member and the valve holding member. Thus, since a thickness of the end-face member can be provided thinner, a capacity of a discharge hole of the end-face member is made smaller so that degradation of operating efficiency as well as increase of operating noise are prevented.

### TECHNICAL FIELD

The present invention relates to a compressor such as a rotary compressor to be used in air conditioners or the like.

### BACKGROUND ART

A conventional compressor, as shown in FIG. 10, has an upper frame 100 of a cylinder having a discharge hole 100a opening within the cylinder, a discharge valve 101 for opening and closing the discharge hole 100a of the upper frame 100, a valve holding member 102 for sandwiching the discharge valve 101 in cooperation with the upper frame 100, and a fixing bolt 103. [0003] The valve holding member 102 has a through hole 102a, and the upper frame 100 has a screw hole 100b.

Then, the fixing bolt 103 is inserted into the through hole 102a of the valve holding member 102 and is screwed with the screw hole 100b of the upper frame 100. As a result, the discharge valve 101 is sandwiched and held between the upper frame 100 and the valve holding member 102 (see JP 61-5373 U).

However, with the conventional compressor as shown above, in which the upper frame 100 has the screw hole 100b, there has been a need for increasing the thickness of the upper frame 100 to ensure an effective thread length. This would result in increased axial (thicknesswise) sizes of the screw hole 100b of the upper frame 100, which in turn would result in increased capacities (hereinafter, referred to as top clearance) of the discharge hole 100a of the upper frame 100.

Thus, such a large top clearance would lead to an increased quantity of compressed gas remaining in the discharge hole 100a at an end of compression, which would incur efficiency degradation of the compressor as well as increase of operating noise due to re-expansion of the compressed gas derived from within the discharge hole 100a.

More specifically, the capacity efficiency would lower with a low-speed operation of the compressor, while the motive power would increase with a high-speed operation of the compressor. Besides, a pulsating pressure caused by the re-expansion of compressed gas would incur increase of the operating noise.

### SUMMARY OF THE INVENTION

Accordingly, an object of the present invention is to provide a compressor which is improved in performance with the discharge hole decreased in capacity.

In order to achieve the above object, according to the present invention, there is provided a compressor comprising:

a cylinder body which forms a cylinder chamber;

an end-face member which is mounted on an end face of the cylinder body and which has a discharge hole communicating with the cylinder chamber and a through hole;

a discharge valve for opening and closing the discharge hole of the end-face member;

a valve holding member which sandwiches the discharge valve in cooperation with the end-face member and which has a screw hole; and

a fixing bolt having a head portion, wherein

the head portion of the fixing bolt is placed on one side of the end-face member on which the cylinder body is provided, and the fixing bolt is inserted into the through hole of the end-face member so as to be screwed with the screw hole of the valve holding member, in which state the discharge valve is sandwiched by the end-face member and the valve holding member.

In the compressor of this invention, the fixing bolt is inserted into the through hole of the end-face member and screwed with the screw hole of the valve holding member, in which state the discharge valve is sandwiched by the end-face member and the valve holding member. Therefore, there is no need for threading the through hole of the end-face member, so that a thickness of the end-face member around the through hole can be made thinner. That is, the axial (thicknesswise) size of the discharge hole of the end-face member can be set to a small one.

Thus, the capacity (space) of the discharge hole of the end-face member can be made smaller, so that compressed gas remaining within the discharge hole at an end of compression can be made smaller in quantity. Accordingly, degradation of operating efficiency as well as increase of operating noise caused by re-expansion of the compressed gas derived from within the discharge hole can be prevented. More specifically, the capacity efficiency can be enhanced with a low-speed operation of the compressor, while the motive power can be decreased with a high-speed operation of the compressor. Besides, a pulsating pressure caused by the re-expansion of the compressed gas can be decreased, so that the operating noise can be decreased.

Also, the fixing bolt and the screw hole of the valve holding member are coupled to each other, of course, by a screw. Therefore, in comparison with the case where the valve holding member and the end-face member are fixed by a rivet, it becomes possible to retighten the fixing bolt, as well as to correct alignment between the discharge valve and the discharge hole. Further, in comparison with the case where the valve holding member and the end-face member are fixed by screw and nut, the parts count is decreased so that the assembly working efficiency is improved.

In an embodiment, the cylinder body has, in an end face of the cylinder body, a recessed portion for housing therein the head portion of the fixing bolt.

In the compressor of this embodiment, since the cylinder body has, in an end face of the cylinder body, a recessed portion for housing therein the head portion of the fixing bolt, the head portion of the fixing bolt can be hidden in the recessed portion of the end face of the cylinder body. Thus, since the fixing bolt can be placed so as to avoid the cylinder chamber (compression chamber), the through hole of the end-face member, into which the fixing bolt is to be inserted, does not serve as a bypass passage for the cylinder chamber, thus keeping from any degradation of compression performance.

In an embodiment, the screw hole of the valve holding member is finished by burring process.

In the compressor of this embodiment, since the screw hole of the valve holding member is finished by burring process, an effective thread length can be ensured without increasing the thickness of the valve holding member. Also, a periphery of the screw hole on one side on which the fixing bolt is to be inserted through can be automatically chamfered so as to be rounded, providing a guide for insertion of the fixing bolt to facilitate the assembly.

In an embodiment, the valve holding member is formed of a punched material of steel.

In the compressor of this embodiment, since the valve holding member is formed of a punched material of steel, the number of stage changing steps for the burring process of the screw hole can be reduced. Thus, the valve holding member can be manufactured with low cost.

In an embodiment, the end-face member is formed of a casting or sintered material.

In the compressor of this embodiment, since the end-face member is formed of a casting or sintered material, the end-face member can be manufactured with low cost.

In an embodiment, the discharge valve has a projecting portion which enters into the discharge hole of the end-face member.

In the compressor of this embodiment, since the discharge valve has the projecting portion that enters into the discharge hole of the end-face member, the capacity of the discharge hole of the end-face member can be made further smaller by the entry of the projecting portion of the discharge valve into the discharge hole of the end-face member, so that the compressed gas remaining within the discharge hole at an end of compression can be made further smaller in quantity. Thus, degradation of the operating efficiency as well as increase of the operating noise can be further suppressed.

By the entry of the projecting portion of the discharge valve into the discharge hole of the end-face member, sealability of the discharge valve for the discharge hole can be ensured. Also, when the discharge valve is assembled to the end-face member, performing the positioning with the projecting portion entered into the discharge hole facilitates the assembling of the discharge valve to the end-face member.

In an embodiment, the projecting portion of the discharge valve is formed into such a tapered configuration that the projecting portion becomes thinner at its tip, and

the discharge hole of the end-face member is formed into a tapered configuration corresponding to the configuration of the projecting portion.

In the compressor of this embodiment, since the projecting portion and the discharge hole of the end-face member are formed into tapered configurations, the projecting portion can be fitted into the discharge hole in a generally coincident state, so that sealability of the discharge valve for the discharge hole can be further improved.

In an embodiment, the valve holding member has:

a platy body portion having a hole portion; and

an annular protruding portion provided around the hole portion on one surface of the body portion opposite to a surface on which the discharge valve is provided, wherein

an inner circumferential surface of the hole portion of the body portion is formed into a cylindrical surface and a tapered surface in an order from the one surface side toward the other side of the body portion,

an inner circumferential surface of the annular protruding portion is formed into a cylindrical surface which is equal in diameter to the cylindrical surface of the body portion and which concentrically adjoins the cylindrical surface of the body portion, and

the cylindrical surface of the body portion and the cylindrical surface of the annular protruding portion cooperatively form the screw hole.

In the compressor of this embodiment, since the inner circumferential surface of the hole portion of the body portion in the valve holding member is formed into the cylindrical surface and the tapered surface, the fixing bolt, when inserted into the hole portion of the valve holding member, is aligned by the tapered surface of the hole portion, so that the fixing bolt can be led to the screw hole with reliability.

Also, the portion of the body portion where the tapered surface is formed comes to have elasticity, so that the screw hole becomes reducible or expandable in diameter. Accordingly, when the fixing bolt is screwed with the screw hole, any initial loosening of the fixing bolt due to the screw hole can be prevented.

Further, since the cylindrical surface of the body portion and the cylindrical surface of the annular protruding portion cooperatively form the screw hole, the cylindrical surface of the annular protruding portion allows the screw hole to be elongated in thread length.

In an embodiment, the screw hole has a thread length equal to or more than a thickness of the body portion.

In the compressor of this embodiment, since the screw hole has the thread length equal to or more than a thickness of the body portion, the thread length of the screw hole can be ensured even with the thickness of the body portion decreased, so that the fixing bolt can be tightened to the screw hole with reliability.

In an embodiment, a depressed portion for housing therein the discharge valve and the valve holding member is provided in an end face of the end-face member,

the depressed portion has one side face and the other side face which are generally opposed to each other,

the one side face and the other side face are located on both sides of respective sites around the fixing bolt in the discharge valve and the valve holding member so as to allow a positioning of those sites, respectively,

the one side face is placed on one side on which when the fixing bolt is rotated in a direction in which the fixing bolt is tightened to the screw hole of the valve holding member from the cylinder body side of the end-face member, the valve holding member integrally rotates along with the fixing bolt so that a portion of the valve holding member on one side closer to the discharge hole than an axis of the fixing bolt makes contact with the one side face, and

the other side face is placed on one side on which when the fixing bolt is rotated in a direction in which the fixing bolt is tightened to the screw hole of the valve holding member from the cylinder body side of the end-face member, the valve holding member integrally rotates along with the fixing bolt so that a portion of the valve holding member on one side closer to the discharge hole than the axis of the fixing bolt goes away from the other side face.

In the compressor of this embodiment, since the depressed portion has the one side face and the other side face, the discharge valve and the valve holding member, in the tightening of the fixing bolt to the screw hole, are securely blocked by the one side face of the depressed portion even if those are integrally rotated by following the rotation of the fixing bolt. Further, the other side face together with the one side face can easily lead the discharge valve and the valve holding member toward the through hole side.

In an embodiment, a length of the one side face from the through hole toward the discharge hole is longer than a length of the other side face from the through hole toward the discharge hole.

In the compressor of this embodiment, since the length of the one side face from the through hole toward the discharge hole is longer than the length of the other side face from the through hole toward the discharge hole, the discharge valve and the valve holding member, in the tightening of the fixing bolt to the screw hole, are securely blocked by the one side face of the depressed portion even if those are integrally rotated by following the rotation of the fixing bolt. Further, since the other side face is shorter than the one side face, a space of the depressed portion on the other side face side can be made larger so that reduction of the discharge space can be prevented. Accordingly, rotational position accuracy of the discharge valve and the valve holding member in their assembly can be improved by the one side face side of the depressed portion, while increase in discharge pressure loss can be avoided by the other side face side of the depressed portion.

In an embodiment, the discharge valve has a cover portion which goes into or out of contact with the discharge hole, and

when the fixing bolt is rotated in the direction of being tightened from the cylinder body side of the end-face member, the discharge valve integrally rotates along with the valve holding member, and

when a portion of the discharge valve closer to the discharge hole than the axis of the fixing bolt comes into contact with the one side face of the depressed portion, a center of the cover portion of the discharge valve and a center of the discharge hole become generally coincident with each other.

In the compressor of this embodiment, when the discharge valve comes into contact with the one side face of the depressed portion, the center of the cover portion of the discharge valve and the center of the discharge hole become generally coincident with each other. Therefore, when the fixing bolt is tightened to the screw hole, the discharge valve integrally rotates along with the valve holding member by following the rotation of the fixing bolt, thus making contact with the one side face of the depressed portion. Accordingly, tightening the fixing bolt allows the center of the cover portion of the discharge valve and the center of the discharge hole to automatically become generally coincident with each other, so that the positional accuracy of the discharge valve and the discharge hole can be further improved.

In an embodiment, the recessed portion forms a Helmholtz type resonance chamber, and

a connecting passage for connecting the resonance chamber and the cylinder chamber to each other is provided in the cylinder body.

In the compressor of this embodiment, since the recessed portion forms a Helmholtz type resonance chamber, waves of pulsating noise of the refrigerant gas that occurs upon compression in the cylinder chamber interfere with interferential waves derived from the resonance chamber so as to damp to a large extent. Therefore, pulsating noise decreases, so that a reduction of noise can be achieved. Thus, the recessed portion can be used both as a space for housing the bolt head portion therein and as a resonance chamber.

### BRIEF DESCRIPTION OF THE DRAWINGS

FIG. 1 is a sectional view showing a first embodiment of a compressor according to the present invention;

FIG. 2 is a plan view of the compressor;

FIG. 3 is a main-part enlarged sectional view showing the first embodiment of the compressor of the invention;

FIG. 4 is a main-part enlarged sectional view showing a second embodiment of the compressor of the invention;

FIG. 5 is a main-part enlarged sectional view showing a third embodiment of the compressor of the invention;

FIG. 6 is a main-part enlarged sectional view showing a fourth embodiment of the compressor of the invention;

FIG. 7 is a plan view showing a fifth embodiment of the compressor of the invention;

FIG. 8 is a main-part enlarged sectional view of FIG. 7;

FIG. 9 is a main-part enlarged sectional view showing a sixth embodiment of the compressor of the invention;

FIG. 10 is a main-part enlarged sectional view of a compressor according to a prior art.

### DETAILED DESCRIPTION OF THE INVENTION

Hereinbelow, the present invention will be described in detail by way of embodiments thereof illustrated in the accompanying drawings.

### First Embodiment

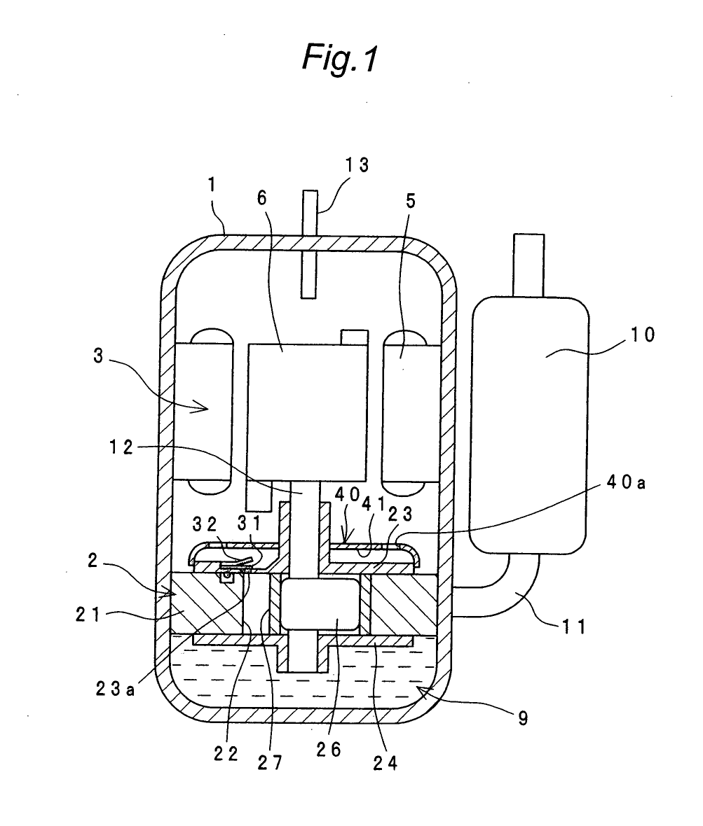

FIG. 1 shows a sectional view of a first embodiment of the compressor of the invention. The compressor of the invention is a rotary compressor of the so-called high-pressure dome type, in which a compression section 2 is placed below and a motor 3 is placed above within a casing 1. The compression section 2 is driven via a drive shaft 12 by a rotor 6 of the motor 3.

The compression section 2 sucks in a wet gas (refrigerant) through a suction pipe 11 from an accumulator 10. The wet gas can be obtained by controlling a condenser, an expansion mechanism and an evaporator (not shown) which constitute an air conditioner as an example of a refrigeration system together with this compressor.

The compressor discharges a compressed high-temperature, high-pressure discharge gas from the compression section 2 to fill the inside of the casing 1 therewith and, moreover, to cool the motor 3 through a clearance between a stator 5 and the rotor 6 of the motor 3, and thereafter discharges outside through a discharge pipe 13. Below a high-pressure region within the casing 1 is accumulated lubricating oil 9.

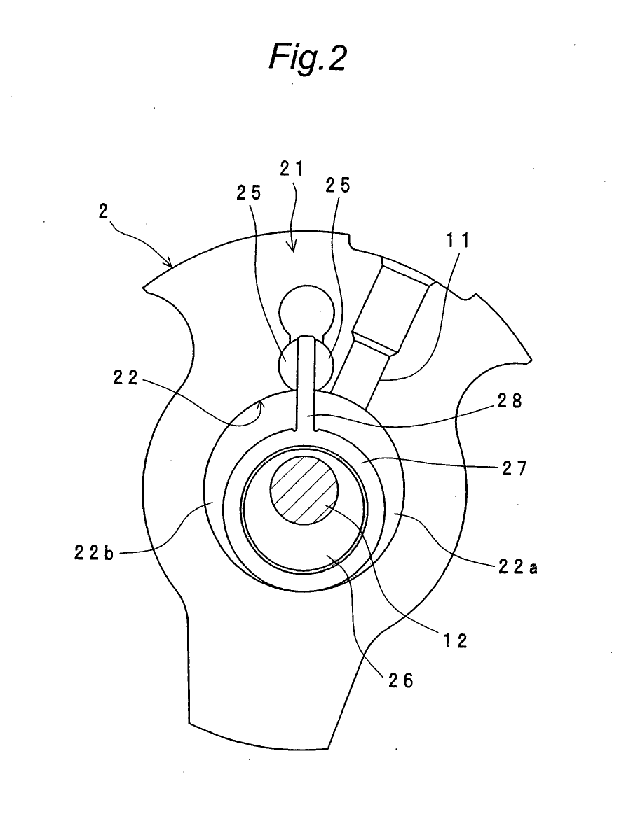

As shown in FIGS. 1 and 2, the compression section 2 includes a cylinder body 21 forming a cylinder chamber 22, and an upper end-face member 23 and a lower end-face member 24 which are mounted at upper-and-lower end faces of the cylinder body 21 to cover the cylinder chamber 22.

The drive shaft 12 extends through the upper end-face member 23 and the lower end-face member 24, running to the inside of the cylinder chamber 22.

A roller 27 fitted into a crankpin 26 provided on the drive shaft 12 is revolvably placed in the cylinder chamber 22, so that the compression action can be achieved by revolution of the roller 27.

The interior of the cylinder chamber 22 is partitioned by a blade 28 provided integrally with the roller 27. That is, as shown in FIG. 2, in a chamber on the right side of the blade 28, the suction pipe 11 opens to an inner surface of the cylinder chamber 22 to form a suction chamber 22a. Meanwhile, in a chamber on the left signal of the blade 28, a discharge hole 23a shown in FIG. 1 opens to an inner surface of the cylinder chamber 22 to form a discharge chamber 22b.

On both side faces of the blade 28, semicircular bushes 25, 25 are provided tight to seal those surfaces. Between the blade 28 and the bushes 25, 25, lubrication is provided by the lubricating oil 9.

With regard to operation of the compression section 2, as the crankpin 26 eccentrically rotates along with the drive shaft 12, the roller 27 fitted to the crankpin 26 revolves while an outer circumferential surface of the roller 27 is kept in contact with the inner circumferential surface of the cylinder chamber 22.

As the roller 27 revolves within the cylinder chamber 22, the blade 28 advances and retreats with both side faces of the blade 28 held by the bushes 25, 25. Then, the low-pressure refrigerant is sucked from the suction pipe 11 into the suction chamber 22a. After the refrigerant is compressed to a high pressure in the discharge chamber 22b, the high-pressure refrigerant is discharged through the discharge hole 23a.

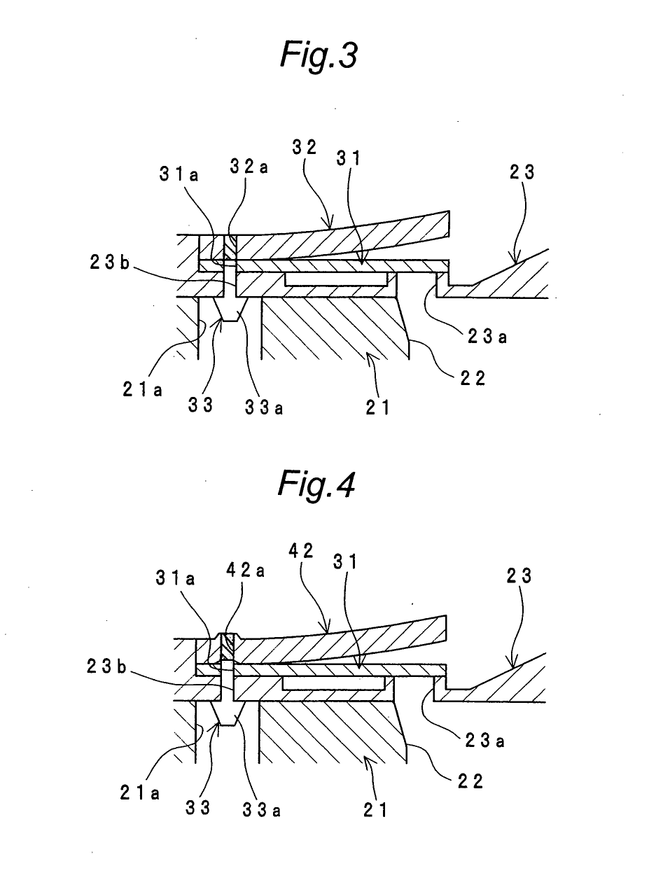

As shown in FIGS. 1 and 3, the upper end-face member 23 (hereinafter, referred to as end-face member 23) has the discharge hole 23a communicating with the cylinder chamber 22, and a through hole 23b provided outside and near the discharge hole 23a.

A platy discharge valve 31 and a platy valve holding member 32 are provided at the end-face member 23. The discharge valve 31 opens and closes the discharge hole 23a, while the valve holding member 32 sandwiches and holds the discharge valve 31 in cooperation with the end-face member 23. The discharge valve 31 has a hole portion 31a, and the valve holding member 32 has a screw hole 32a.

The discharge valve 31 and the valve holding member 32 are fixed to the end-face member 23 by a fixing bolt 33. That is, a head portion 33a of the fixing bolt 33 is placed on one side of the end-face member 23 facing the cylinder body 21, the fixing bolt 33 is inserted into the through hole 23b of the end-face member 23 as well as into the hole portion 31a of the discharge valve 31, and is screwed with the screw hole 32a of the valve holding member 32, in which state the discharge valve 31 is sandwiched and held by the end-face member 23 and the valve holding member 32.

The discharge valve 31 in a free state closes the discharge hole 23a. When the refrigerant (compressed gas) within the cylinder chamber 22 has reached to a specified pressure, the compressed gas, elastically deforming the discharge valve 31, is discharged through the discharge hole 23a. It is noted that the valve holding member 32 suppresses motion of the discharge valve 31 so as to prevent the discharge valve 31 from being deformed (swinging) more than necessary.

At the end-face member 23, a cup-shaped muffler body 40 is mounted so as to cover the discharge valve 31. This muffler body 40 is fixed to the end-face member 23 by a fixing member (such as a bolt).

The muffler body 40 and the end-face member 23 define a muffler chamber 41. The muffler chamber 41 and the cylinder chamber 22 are communicated with each other via the discharge hole 23a.

The muffler body 40 has a hole portion 40a. The hole portion 40a makes the muffler chamber 41 communicated with outside of the muffler body 40.

According to the compressor of this construction, the fixing bolt 33 is inserted into the through hole 23b of the end-face member 23 and screwed with the screw hole 32a of the valve holding member 32, in which state the discharge valve 31 is sandwiched and held between the end-face member 23 and the valve holding member 32. Therefore, without the need for threading the through hole 23b of the end-face member 23, thickness around the through hole 23b of the end-face member 23 can be reduced. That is, the axial (thicknesswise) size of the discharge hole 23a of the end-face member 23 is made smaller.

Thus, the capacity (hereinafter, referred to as top clearance) of the discharge hole 23a of the end-face member 23 is made smaller, so that the compressed gas remaining within the discharge hole 23a at an end of compression is made smaller in quantity.

Accordingly, degradation of the operating efficiency as well as increase of the operating noise caused by re-expansion of the compressed gas derived from within the discharge hole 23a can be prevented. More specifically, the capacity efficiency can be enhanced with a low-speed operation of the compressor, while the motive power can be decreased with a high-speed operation of the compressor. Besides, a pulsating pressure caused by the re-expansion of the compressed gas can be decreased, so that the operating noise can be decreased.

Further, the fixing bolt 33 and the screw hole 32a of the valve holding member 32 are coupled to each other by a screw. Therefore, in comparison with the case where the valve holding member 32 and the end-face member 23 are fixed by a rivet, it becomes possible to retighten the fixing bolt 33, as well as to correct alignment between the discharge valve 31 and the discharge hole 23a, thus facilitating, for example, the fitting of seal.

Further, in comparison with the case where the valve holding member 32 and the end-face member 23 are fixed by screw and nut, the parts count is decreased so that the assembly working efficiency is improved.

The cylinder body 21 has, at an end face thereof, a recessed portion 21a for housing therein the head portion 33a of the fixing bolt 33. Thus, the head portion 33a of the fixing bolt 33 can be hidden in the recessed portion 21a of the end face of the cylinder body 21. Accordingly, since the fixing bolt 33 can be placed so as to avoid the cylinder chamber 22, the through hole 23b of the end-face member 23, into which the fixing bolt 33 is to be inserted, does not serve as a bypass passage for the cylinder chamber 22, thus keeping from any degradation of compression performance.

The end-face member 23 is formed of a casting or sintered material. Thus, the end-face member 23 can be manufactured with low cost. That is, even if the end-face member 23 is made smaller in thickness at a portion thereof where the discharge valve 31 is fixed, the end-face member 23 is burdened by only a compressive stress. This allows the end-face member 23 to be formed of a casting or sintered material, which is a fragile material.

### Second Embodiment

FIG. 4 shows a second embodiment of the invention. In this second embodiment, a screw hole 42a of a valve holding member 42 is finished by burring process. The valve holding member 42 is made of a punched material of expandable steel. It is noted that component members designated by like reference numerals in conjunction with the first embodiment are identical in construction to those of the first embodiment, and so their description is omitted.

Thus, since the screw hole 42a of the valve holding member 42 is finished by burring process, an effective thread length can be ensured without increasing the thickness of the valve holding member 42. Also, a periphery of the screw hole 42a on one side on which the fixing bolt 33 is to be inserted through can be automatically chamfered so as to be rounded, providing a guide for insertion of the fixing bolt 33 to facilitate the assembly.

Since the valve holding member 42 is formed of a punched material of steel, the number of stage changing steps for the burring process of the screw hole 42a can be reduced. Thus, the valve holding member 42 can be manufactured with low cost.

### Third Embodiment

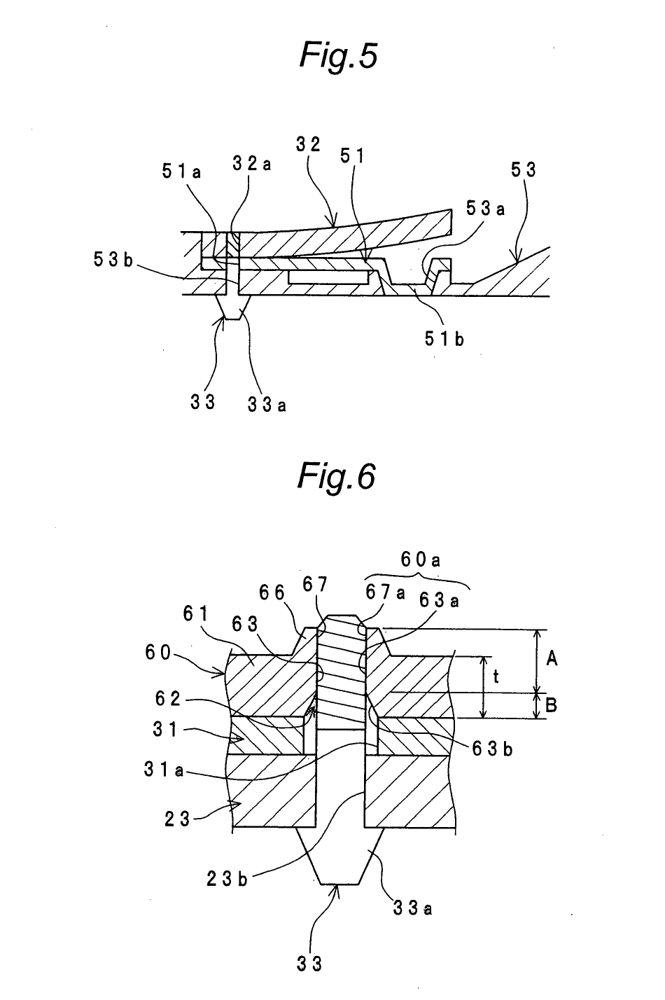

FIG. 5 shows a third embodiment of the invention. In this third embodiment, an end-face member 53 has a discharge hole 53a through which compressed gas is discharged, and a through hole 53b into which the fixing bolt 33 is to be inserted through. A discharge valve 51 has a hole portion 51a through which the fixing bolt 33 is to be inserted, and a projecting portion 51b which projects into the discharge hole 53a of the end-face member 53. It is noted that component members designated by like reference numerals in conjunction with the first embodiment are identical in construction to those of the first embodiment, and so their description is omitted.

More specifically, the projecting portion 51b of the discharge valve 51 is formed into such a tapered configuration that the projecting portion 51b becomes thinner at its tip. The discharge hole 53a of the end-face member 53 is formed into a tapered configuration corresponding to the configuration of the projecting portion 51b.

Thus, since the discharge valve 51 has a projecting portion 51b that enters into the discharge hole 53a of the end-face member 53, the capacity of the discharge hole 53a of the end-face member 53 can be made further smaller by the entry of the projecting portion 51b of the discharge valve 51 into the discharge hole 53a of the end-face member 53, so that the compressed gas remaining within the discharge hole 53a at an end of compression can be made further smaller in quantity. Accordingly, degradation of the operating efficiency as well as increase of the operating noise can be further suppressed.

By the entry of the projecting portion 51b of the discharge valve 51 into the discharge hole 53a of the end-face member 53, sealability of the discharge valve 51 for the discharge hole 53a can be ensured. Also, when the discharge valve 51 is assembled to the end-face member 53, performing the positioning with the projecting portion 51b entered into the discharge hole 53a facilitates the assembling of the discharge valve 51 to the end-face member 53.

Also, since the projecting portion 51b and the discharge hole 53a are formed into tapered configurations, the projecting portion 51b can be fitted into the discharge hole 53a in a generally coincident state, so that sealability of the discharge valve 51 for the discharge hole 53a can be further improved.

Still also, since the axial size of the discharge hole 53a is a small one, the projecting portion 51b can be set to a small height size. Thus, since the projecting portion 51b can be set small in height size, degradation of parts precision in the projecting portion 51b can be prevented.

### Fourth Embodiment

FIG. 6 shows a fourth embodiment of the invention. In this fourth embodiment, a valve holding member 60 has a platy body portion 61, and an annular protruding portion 66 provided on one surface of the body portion 61 opposite to a surface on which the discharge valve 31 is provided. It is noted that component members designated by like reference numerals in conjunction with the first embodiment shown in FIG. 3 are identical in construction to those of the first embodiment, and so their description is omitted.

The body portion 61 has a hole portion 62. An inner circumferential surface 63 of the hole portion 62 of the body portion 61 is formed into a cylindrical surface 63a and a tapered surface 63b in an order from the one surface to the other surface of the body portion 61. The cylindrical surface 63a extends thicknesswise of the body portion 61. The tapered surface 63b stretches so as to be wider increasingly on the other surface side of the body portion 61. That is, the tapered surface 63b forms a chamfered surface.

The annular protruding portion 66 is provided so as to surround the hole portion 62 of the body portion 61. An inner circumferential surface 67 of the annular protruding portion 66 is formed into a cylindrical surface 67a. The cylindrical surface 67a is equal in diameter to the cylindrical surface 63a of the body portion 61, and concentrically adjoins the cylindrical surface 63a of the body portion 61.

The cylindrical surface 63a of the body portion 61 and the cylindrical surface 67a of the annular protruding portion 66 form a screw hole 60a in cooperation. The cylindrical surface 67a of the annular protruding portion 66 allows the screw hole 60a to be elongated in thread length. That is, the screw hole 60a has a thread length A equal to or more than a thickness t of the body portion 61.

The tapered surface 63b and the annular protruding portion 66 are formed, for example, by a punching press. That is, the tapered surface 63b of the body portion 61, the cylindrical surface 63a of the body portion 61, and the cylindrical surface 67a of the annular protruding portion 66 are formed in a punching order.

According to the compressor of this construction, since the inner circumferential surface 63 of the hole portion 62 in the body portion 61 of the valve holding member 60 is formed into the cylindrical surface 63a and the tapered surface 63b, the fixing bolt 33, when inserted into the hole portion 62 of the valve holding member 60, is aligned by the tapered surface 63b of the hole portion 62, so that the fixing bolt 33 can be led to the screw hole 60a with reliability.

Also, the portion of the body portion 61 where the tapered surface 63b is formed comes to have elasticity, so that the screw hole 60a becomes reducible or expandable in diameter. That is, the tapered surface 63b of the body portion 61 serves as a flexural margin B of the elasticity. Accordingly, when the fixing bolt 33 is screwed with the screw hole 60a, any initial loosening of the fixing bolt 33 due to the screw hole 60a can be prevented.

Further, since the screw hole 60a has the thread length A equal to or more than the thickness t of the body portion 61, the thread length A of the screw hole 60a can be ensured even with the thickness t of the body portion 61 decreased, so that the fixing bolt 33 can be tightened to the screw hole 60a with reliability.

Thus, since the fixing bolt 33 becomes less liable to loosening, the fixing bolt 33 is prevented from falling into the cylinder body 21 even if the head portion 33a of the fixing bolt 33 is located on the cylinder body 21 side (shown in FIG. 3). As a consequence, there is no need for disassembling the assembled end-face member 23 and cylinder body 21 to take out the fixing bolt 33 that has fallen within the cylinder body 21, hence high reliability and good durability.

### Fifth Embodiment

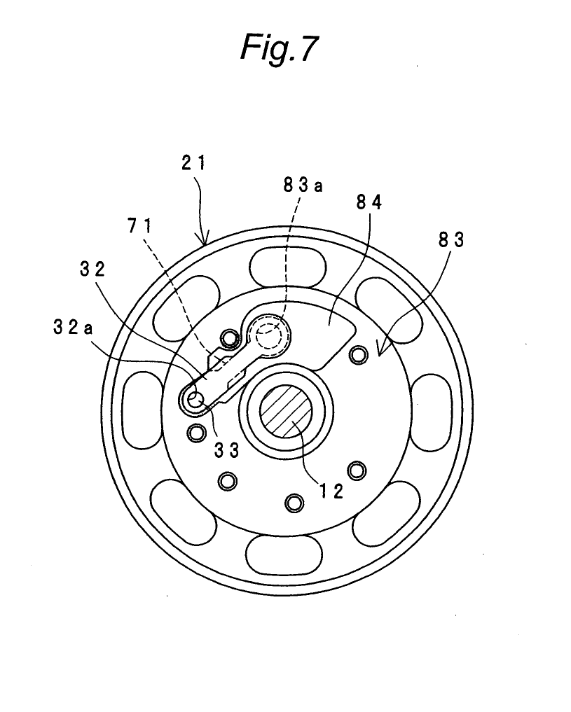

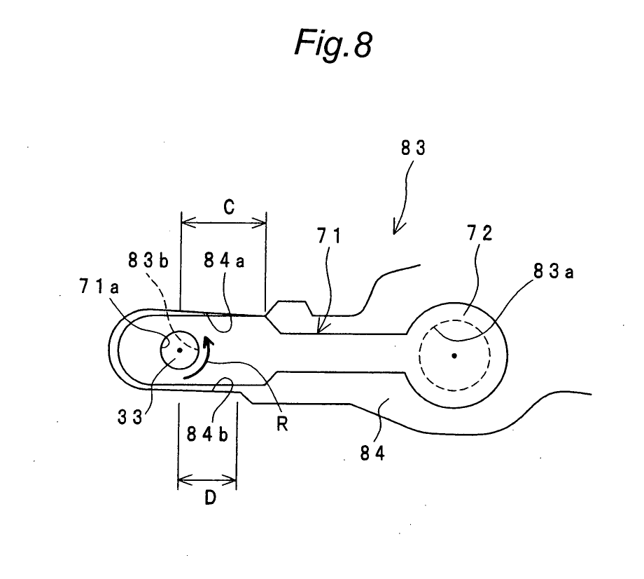

FIGS. 7 and 8 show a fifth embodiment of the invention. In this fifth embodiment, a depressed portion 84 for housing therein a discharge valve 71 and the valve holding member 32 is provided in an end face of an end-face member 83. It is noted that component members designated by like reference numerals in conjunction with the first embodiment shown in FIG. 3 are identical in construction to those of the first embodiment, and so their description is omitted.

The depressed portion 84 has one side face 84a and the other side face 84b generally oppositely confronting each other. For general positioning of respective sites of the discharge valve 71 and the valve holding member 32 around the fixing bolt 33, the one side face 84a and the other side face 84b are located on both sides of those sites, respectively.

The one side face 84a and the other side face 84b extend from a through hole 83b toward a discharge hole 83a. The discharge hole 83a and the through hole 83b are provided in the end-face member 83, as is the case also with the discharge hole 23a and the through hole 23b in the end-face member 23 shown in FIG. 3.

The one side face 84a is placed on one side on which when the fixing bolt 33 is rotated in a direction in which the fixing bolt 33 is tightened to the screw hole 32a of the valve holding member 32 from the cylinder body 21 side of the end-face member 83, the valve holding member 32 integrally rotates along with the fixing bolt 33 so that a portion of the valve holding member 32 on one side closer to the discharge hole 83a than the axis of the fixing bolt 33 makes contact with the one side face 84a. In FIG. 8, the direction in which the fixing bolt 33 is tightened is indicated by an arrow R.

The other side face 84b is placed on one side on which when the fixing bolt 33 is rotated in a direction in which the fixing bolt 33 is tightened to the screw hole 32a of the valve holding member 32 from the cylinder body 21 side of the end-face member 83, the valve holding member 32 integrally rotates along with the fixing bolt 33 so that a portion of the valve holding member 32 on one side closer to the discharge hole 83a than the axis of the fixing bolt 33 goes away from the other side face 84b.

A length C of the one side face 84a from the through hole 83b toward the discharge hole 83a is longer than a length D of the other side face 84b from the through hole 83b toward the discharge hole 83a. In more detail, a comparison is made about a length component that connects a center of the discharge hole 83a and a center of the through hole 83b to each other as viewed along an axial direction of the fixing bolt 33.

Side faces of respective sites of the discharge valve 71 and the valve holding member 32 around the fixing bolt 33 are generally parallel to the line connecting the through hole 83b and the discharge hole 83a to each other. The one side face 84a and the other side face 84b are smooth surfaces and are slightly inclined with respect to the line connecting the through hole 83b and the discharge hole 83a to each other.

The discharge valve 71 has a cover portion 72 which goes into or out of contact with the discharge hole 83a. When the fixing bolt 33 is rotated in the direction of being tightened from the cylinder body 21 side of the end-face member 83, the discharge valve 71 integrally rotates along with the valve holding member 32 due to friction with the valve holding member 32.

Then, when the portion of the discharge valve 71 closer to the discharge hole 83a than the axis of the fixing bolt 33 comes into contact with the one side face 84a of the depressed portion 84, the center of the cover portion 72 of the discharge valve 71 and the center of the discharge hole 83a become generally coincident with each other.

According to the compressor of this construction, since the length C of the one side face 84a from the through hole 83b toward the discharge hole 83a is longer than the length D of the other side face 84b from the through hole 83b toward the discharge hole 83a, the discharge valve 71 and the valve holding member 32, in the tightening of the fixing bolt 33 to the screw hole 32a, are securely blocked by the one side face 84a of the depressed portion 84 even if those are integrally rotated along with the rotation of the fixing bolt 33.

Also, since the other side face 84b is shorter than the one side face 84a, a space of the depressed portion 84 on the other side face 84b side can be made larger so that reduction of the discharge space can be prevented. That is, since the muffler body 40 is mounted on the end-face member 83 as shown in FIG. 1, the possibility that the space of the depressed portion 84 can be enlarged makes it possible to enlarge the space of the muffler chamber 41. It is noted that in FIG. 7, the muffler body 40 is omitted in illustration.

Further, the other side face 84b together with the one side face 84a can easily lead the discharge valve 71 and the valve holding member 32 toward the through hole 83b.

Accordingly, rotational position accuracy of the discharge valve 71 and the valve holding member 32 in their assembly can be improved by the one side face 84a side of the depressed portion 84, while increase in discharge pressure loss can be avoided by the other side face 84b side of the depressed portion 84.

Also, when the discharge valve 71 comes into contact with the one side face 84a of the depressed portion 84, the center of the cover portion 72 of the discharge valve 71 and the center of the discharge hole 83a become generally coincident with each other. Therefore, in the tightening of the fixing bolt 33 to the screw hole 32a, the discharge valve 71 integrally rotates along with the valve holding member 32 by following the rotation of the fixing bolt 33, thus making contact with the one side face 84a of the depressed portion 84. Accordingly, tightening the fixing bolt 33 allows the center of the cover portion 72 of the discharge valve 71 and the center of the discharge hole 83a to automatically become generally coincident with each other, so that the positional accuracy of the discharge valve 71 and the discharge hole 83a can be further improved.

In short, the one side face 84a has a function of positioning the discharge valve 31. The one side face 84a and the other side face 84b have a function of guiding the discharge valve 71 and the valve holding member 32.

In addition, the one side face 84a may be other than a smooth surface and have a protruding portion, while the discharge valve 71 may be so set that upon its contact with the protruding portion of the one side face 84a, the center of the cover portion 72 of the discharge valve 71 and the center of the discharge hole 83a become generally coincident with each other. The length C of the one side face 84a may also be one which is not longer than the length D of the other side face 84b, where the discharge valve 71 and the valve holding member 32, in the tightening of the fixing bolt 33, are blocked by the one side face 84a of the depressed portion 84 even if those are integrally rotated by following the rotation of the fixing bolt 33.

### Sixth Embodiment

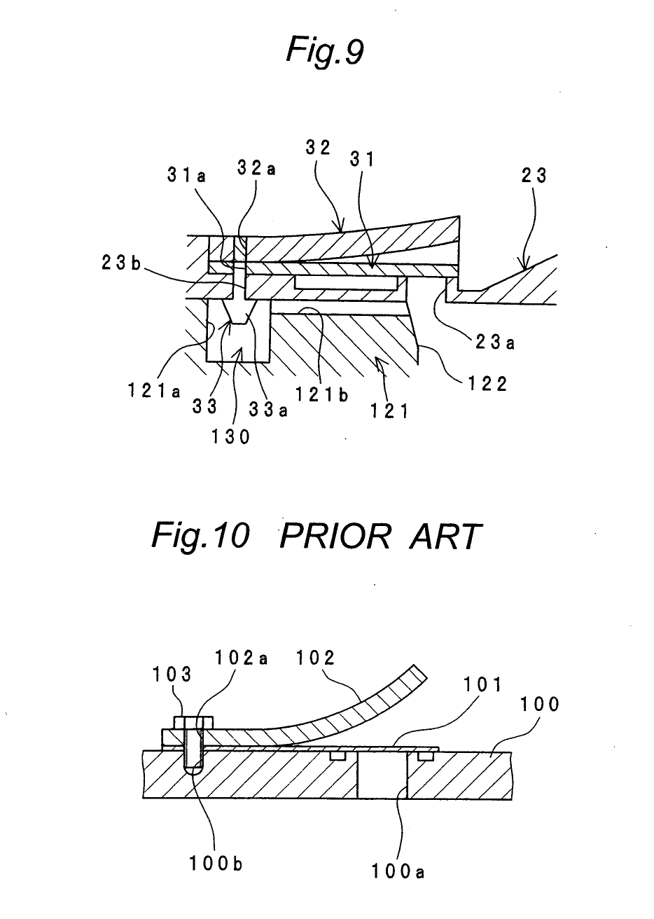

FIG. 9 shows a sixth embodiment of the invention. In this sixth embodiment, a recessed portion 121a for housing therein the head portion 33a of the fixing bolt 33 is provided at an end face of a cylinder body 121, where the recessed portion 121a forms a Helmholtz type resonance chamber 130. It is noted that component members designated by like reference numerals in conjunction with the first embodiment shown in FIG. 3 are identical in construction to those of the first embodiment, and so their description is omitted.

The resonance chamber 130 is a space defined by the recessed portion 121a and the end-face member 23. In the cylinder body 121, a connecting passage 121b for connecting the resonance chamber 130 and a cylinder chamber 122 to each other is provided.

The connecting passage 121b is a groove provided in an end face of the cylinder body 121. The connecting passage 121b opens near the discharge hole 23a. The connecting passage 121b may also be formed as a hole extending through the cylinder body 121.

According to the compressor of this construction, since the recessed portion 121a forms the Helmholtz type resonance chamber 130, waves of pulsating noise of the refrigerant gas that occurs upon compression in the cylinder chamber 122 interfere with waves derived from the resonance chamber 130 so as to damp to a large extent. Therefore, pulsating noise decreases, so that a reduction of noise can be achieved. Thus, the recessed portion 121a can be used both as a space for housing the bolt head portion 33a therein and as a resonance chamber.

The present invention is not limited to the foregoing embodiments. For example, although the foregoing embodiments have been described on a swing compressor in which the roller 27 and the blade 28 are integrated together, yet the invention may be applied to a compressor in which the roller and the blade are provided separate from each other. The compressor may also be a reciprocating compressor. It is also possible that the discharge valve 31 has no hole portion 31a through which the fixing bolt 33 is to be inserted, and the discharge valve 31 may be sandwiched and held by the end-face member 23 and the valve holding member 32. Further, the discharge valve 31, 51, 71, the valve holding member 32, 42, 60 and the fixing bolt 33 may also be mounted on the lower end-face member 24. The recessed portion 21a, which is not limited to a space having a bottom face, may also be a hole extending through the cylinder body 21.

1. A compressor comprising:
a cylinder body which forms a cylinder chamber;
an end-face member which is mounted on an end face of the cylinder body and which has a discharge hole communicating with the cylinder chamber and a through hole;
a discharge valve for opening and closing the discharge hole of the end-face member;
a valve holding member which sandwiches the discharge valve in cooperation with the end-face member and which has a screw hole; and
a fixing bolt having a head portion,
the head portion of the fixing bolt being placed on one side of the end-face member on which the cylinder body is provided, and the fixing bolt being inserted into the through hole of the end-face member so as to be screwed with the screw hole of the valve holding member, in which state the discharge valve is sandwiched by the end-face member and the valve holding member.

2. The compressor as claimed in claim 1, wherein
the cylinder body has, in an end face of the cylinder body, a recessed portion for housing therein the head portion of the fixing bolt.

3. The compressor as claimed in claim 1, wherein
the screw hole of the valve holding member is finished by burring process.

4. The compressor as claimed in claim 3, wherein
the valve holding member is formed of a punched material of steel.

5. The compressor as claimed in claim 1, wherein
the end-face member is formed of a casting or sintered material.

6. The compressor as claimed in claim 1, wherein
the discharge valve has a projecting portion which enters into the discharge hole of the end-face member.

7. The compressor as claimed in claim 6, wherein
the projecting portion of the discharge valve is formed into such a tapered configuration that the projecting portion becomes thinner at its tip, and
the discharge hole of the end-face member is formed into a tapered configuration corresponding to the configuration of the projecting portion.

8. The compressor as claimed in claim 1, wherein
the valve holding member has:
a plate body portion having a hole portion; and
an annular protruding portion provided around the hole portion on one surface of the body portion opposite to a surface on which the discharge valve is provided, wherein
an inner circumferential surface of the hole portion of the body portion is formed into a cylindrical surface and a tapered surface in an order from the one surface side toward the other side of the body portion,
an inner circumferential surface of the annular protruding portion is formed into a cylindrical surface which is equal in diameter to the cylindrical surface of the body portion and which concentrically adjoins the cylindrical surface of the body portion, and
the cylindrical surface of the body portion and the cylindrical surface of the annular protruding portion cooperatively form the screw hole.

9. The compressor as claimed in claim 8, wherein
the screw hole has a thread length equal to or more than a thickness of the body portion.

10. The compressor as claimed in claim 1, wherein
a depressed portion for housing therein the discharge valve and the valve holding member is provided in an end face of the end-face member,
the depressed portion has one side face and the other side face which are generally opposed to each other,
the one side face and the other side face are located on both sides of respective sites around the fixing bolt in the discharge valve and the valve holding member so as to allow a positioning of those sites, respectively,
the one side face is placed on one side on which when the fixing bolt is rotated in a direction in which the fixing bolt is tightened to the screw hole of the valve holding member from the cylinder body side of the end-face member (83), the valve holding member integrally rotates along with the fixing bolt so that a portion of the valve holding member on one side closer to the discharge hole than an axis of the fixing bolt makes contact with the one side face, and
the other side face is placed on one side on which when the fixing bolt is rotated in a direction in which the fixing bolt is tightened to the screw hole of the valve holding member from the cylinder body side of the end-face member, the valve holding member integrally rotates along with the fixing bolt so that a portion of the valve holding member on one side closer to the discharge hole than the axis of the fixing bolt goes away from the other side face.

11. The compressor as claimed in claim 10, wherein
a length of the one side face from the through hole toward the discharge hole is longer than a length of the other side face from the through hole toward the discharge hole.

12. The compressor as claimed in claim 10, wherein
the discharge valve has a cover portion which goes into or out of contact with the discharge hole, and
when the fixing bolt is rotated in the direction of being tightened from the cylinder body side of the end-face member, the discharge valve integrally rotates along with the valve holding member, and
when a portion of the discharge valve closer to the discharge hole than the axis of the fixing bolt comes into contact with the one side face of the depressed portion, a center of the cover portion of the discharge valve and a center of the discharge hole become generally coincident with each other.

13. The compressor as claimed in claim 2, wherein
the recessed portion forms a Helmholtz type resonance chamber, and
a connecting passage for connecting the resonance chamber and the cylinder chamber to each other is provided in the cylinder body.
